(19) United States
(12) Patent Application Publication
(10) Pub. No.: US 2025/0268227 A1
(43) Pub. Date: Aug. 28, 2025

(54) PET HOUSING APPARATUS

(71) Applicant: Madison Beckley, Corona Del Mar, CA (US)

(72) Inventor: Madison Beckley, Corona Del Mar, CA (US)

(21) Appl. No.: 18/406,960

(22) Filed: Jan. 8, 2024

(51) Int. Cl. A01K 1/03; A47B 96/20

(52) U.S. Cl. CPC A01K 1/033; A47B 96/20

(57) ABSTRACT

A pet housing apparatus can include a panel, the panel being constructed to at least partially cover a first opening at a back side or bottom side of a furniture item; wherein the panel is further constructed to at least partially define a second opening; wherein the second opening is smaller than the first opening; and wherein the second opening is constructed to accommodate a pet.

### TECHNICAL FIELD

The embodiments generally relate to the field of pet housing apparatuses.

### BACKGROUND

A pet house may compromise the general aesthetics inside a home while occupying additional space therein. A cabinet in a home may have one or more compartments that are normally unused.

There is a need for a pet housing apparatus that includes a suitable panel that is constructed to attach onto a cabinet, thereby forming a pet house that does not occupy additional space inside the home.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed pet housing apparatus that can include a panel, the panel being constructed to at least partially cover a first compartment opening at a back side or bottom side of a furniture item; wherein the panel is further constructed to at least partially define a first panel opening; wherein the first panel opening is smaller than the first compartment opening. In some embodiments, the first panel opening can be constructed to accommodate a house cat.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a first view of a pet housing apparatus, according to some embodiments disclosed herein;

FIG. 2 illustrates a second view of a pet housing apparatus, according to some embodiments disclosed herein;

FIG. 3 illustrates a third view of a pet housing apparatus, according to some embodiments disclosed herein;

FIG. 4 illustrates a view of a second pet housing apparatus, according to some embodiments disclosed herein;

FIG. 5 illustrates a first view of a pet housing apparatus, according to some embodiments disclosed herein; and

FIG. 6 illustrates a second view of a pet housing apparatus, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments disclosed herein relate to pet housing apparatus. In some embodiments, the pet housing apparatus can include a panel, the panel being constructed to at least partially cover a first compartment opening at a back side or bottom side of a furniture item. The panel can be further constructed to at least partially define a first panel opening; wherein the first panel opening is smaller than the first compartment opening. In some embodiments, the first panel opening can be constructed to accommodate a house cat. In some embodiments, a first compartment of the furniture item can be constructed and arranged to accommodate the house cat.

In some embodiments, the furniture item can be a cabinet. In some embodiments, the furniture item can be a television stand that is constructed and arranged to support at least a television. In some embodiments, the furniture item and the panel can comprise wood or wood material.

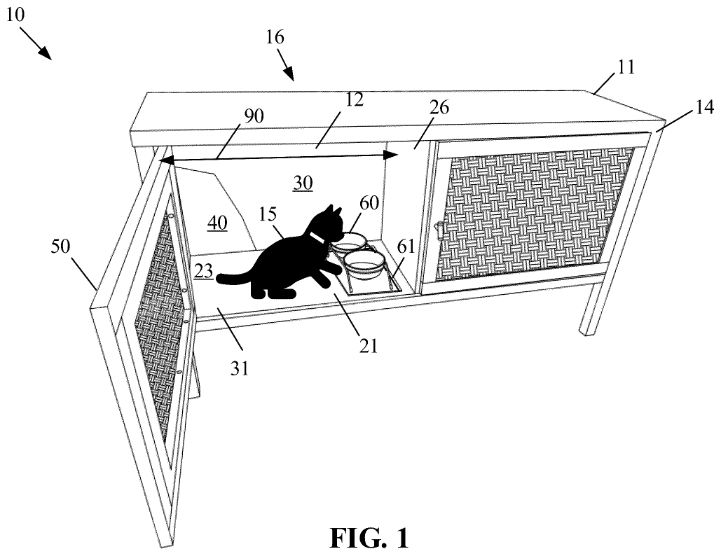

Referring to FIG. 1, a pet housing apparatus 10 can include a first panel 12. In some embodiments, the first panel 12 can be constructed and arranged to at least partially cover a first compartment opening 30 at a back side 16 of a furniture item 11. In some embodiments, the furniture item 11 can be a cabinet 11. In some embodiments, the furniture item 11 can be elongate. In some embodiments, the first panel 12 can be constructed and arranged to at least partially define a first panel opening 40. In some embodiments, the first panel opening 40 can be smaller than the first compartment opening 30.

In some embodiments, the pet housing apparatus 10 can include the furniture item 11. In some embodiments, the first compartment opening 30 at the back side 16 of the furniture item 11 can be the first compartment opening 30 of a first compartment 21 of the furniture item 11. In some embodiments, a first enclosure 26 of the furniture item 11 can define the first compartment 21. In some embodiments, a bottom surface 23 of the first enclosure 26 can at least partially define the first compartment opening 30. In some embodiments, a portion of the bottom surface 23 of the first enclosure 26 can at least partially define the first panel opening 40. In some embodiments, a recess 61 in the bottom surface of the first enclosure 26 can be constructed and arranged to receive one or more bowls 60 (e.g., pet bowls). In some embodiments, the first compartment 21 can be constructed and arranged to accommodate the one or more bowls 60.

In some embodiments, the first compartment 21 can have another opening 31 at the front side 14 opposite the back side 16 of the furniture item 11. In some embodiments, a first door 50 can be constructed and arranged to cover and close the other opening 31.

In some embodiments, the first compartment 21 can be constructed and arranged to accommodate a pet such as, for example, a house cat 15. In some embodiments, the first panel opening 40 can be constructed and arranged to accommodate a pet such as, for example, the house cat 15. The house cat 15 can enter the first compartment 21 through the first panel opening 40. Accordingly, in some embodiments, the first panel opening 40 can be considered as a first pet opening 40.

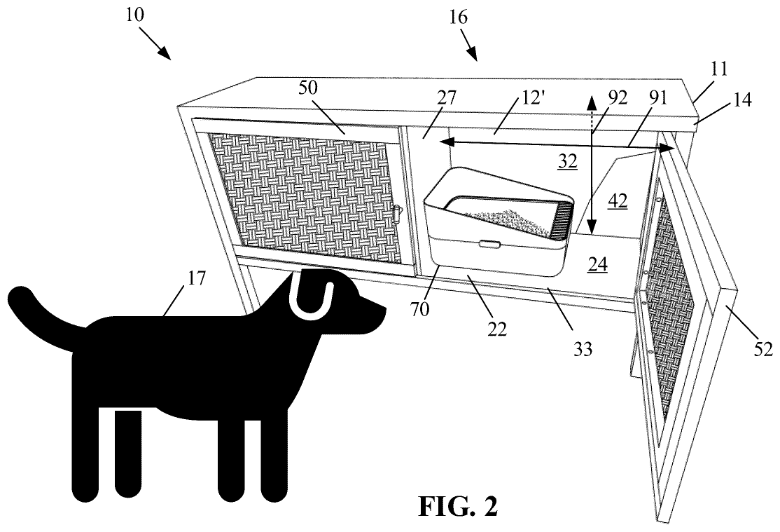

Referring to FIG. 2, a second panel 12′ can be constructed and arranged to at least partially cover a second compartment opening 32 at the back side 16 of the furniture item 11. In some embodiments, the second panel 12′ can be constructed and arranged to at least partially define a second panel opening 42. In some embodiments, the second panel opening 42 can be smaller than the second compartment opening 32. In some embodiments, the first panel 12 can be integrated with the second panel 12′ so that they form a single panel. In some embodiments, the first panel 12 can be adjacent to the second panel 12′.

In some embodiments, the second compartment opening 32 at the back side 16 of the furniture item 11 can be the second compartment opening 32 of a second compartment 22 of the furniture item 11. In some embodiments, a second enclosure 27 of the furniture item 11 can define the second compartment 22. In some embodiments, a bottom surface 24 of the second enclosure 27 can at least partially define the second compartment opening 32. In some embodiments, a portion of the bottom surface 24 of the second enclosure 27 can at least partially define the second panel opening 42.

In some embodiments, the second compartment 22 can have another opening 33 at the front side 14 opposite the back side 16 of the furniture item 11. In some embodiments, a second door 52 can be constructed and arranged to cover and close the other opening 33. In some embodiments, the second compartment 22 can be constructed and arranged to accommodate at least a pet litter box 70 (e.g., a house cat litter box).

In some embodiments, the second panel opening 42 can be constructed and arranged to accommodate a pet such as, for example, the house cat 15 in FIG. 1. The house cat 15 can enter the second compartment 22 through the second panel opening 42. Accordingly, in some embodiments, the second panel opening 42 can be considered as a second pet opening 42. In some embodiments, the second panel opening 42 can be constructed to not accommodate a larger pet such as, for example, a dog 17. In some embodiments, the second compartment 22 can be constructed and arranged to not accommodate the dog 17. In some embodiments, the dog 17 can be approximately 20 pounds or heavier.

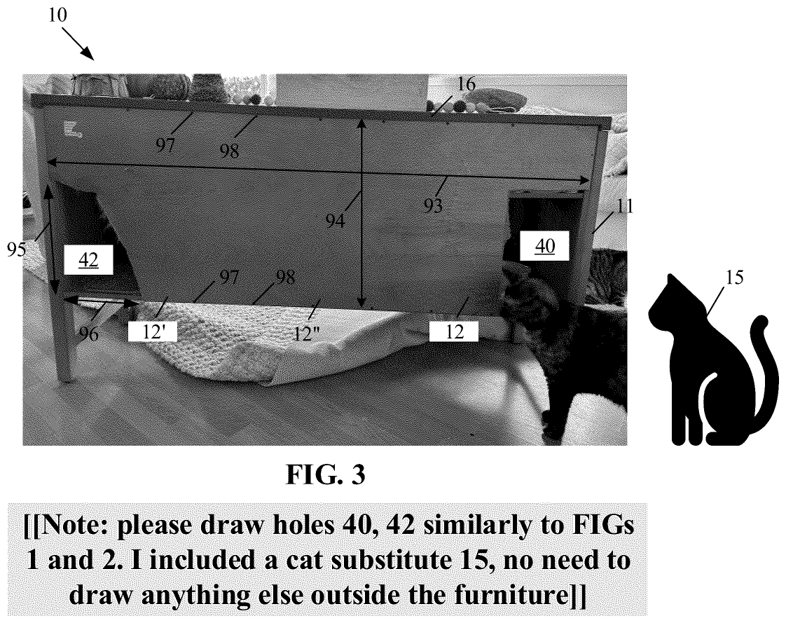

In some embodiments, the second compartment opening 32 can have a first opening dimension 92 (e.g., height). Referring to FIG. 3, a panel 12″ can have a panel dimension 94 (e.g., height) that is substantially the same as the first opening dimension 92.

Referring to FIG. 1, the first compartment 21 can have a first compartment length 90. Referring to FIG. 2, the second compartment 22 can have a second compartment length 91. Referring to FIG. 3, the panel 12″ can have a panel length 93 that is approximately the same or larger than the first compartment length 90, the second compartment length 91, or a combination (e.g., sum) thereof. In some embodiments, the panel 12″ can be elongate.

In some embodiments, any panel opening, such as the second panel opening 42, can have a first dimension 96 (e.g., width) that is approximately 5 inches or larger, and a second dimension 95 (e.g., height) that is approximately 5 inches or larger.

In some embodiments, the panel 12″ can include a plurality of holes 97 that are constructed and arranged to receive fasteners 98 that fasten the panel 12″ to the back side 16 of the furniture item 11.

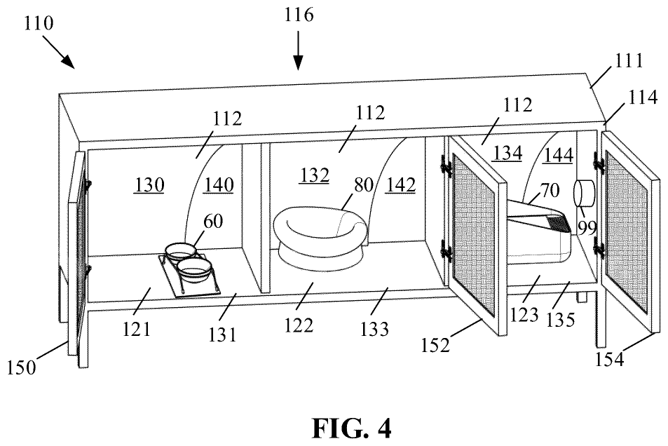

Referring to FIG. 4, a pet housing apparatus 110 can include a furniture item 111 that includes at least a first compartment 121 having a first compartment opening 130, a second compartment 122 having a second compartment opening 132, a third compartment 123 having a third compartment opening 134, any other suitable compartment(s) having compartment opening(s), or any combination thereof.

A panel 112 can be constructed and arranged to at least partially cover the first compartment opening 130, the second compartment opening 132, the third compartment opening 134, any other compartment opening(s), or any combination thereof, at a back side 116 of the furniture item 111. In some embodiments, the panel 112 can be constructed and arranged to at least partially define a first panel opening 140, a second panel opening 142, a third panel opening 144, any other panel opening(s), or any combination thereof. In some embodiments, the first panel opening 140 can be aligned with the first compartment opening 130, the second panel opening 142 can be aligned with the second compartment opening 132, and the third panel opening 144 can be aligned with the third compartment opening 134. In some embodiments, the first panel opening 140 can be smaller than the first compartment opening 130. In some embodiments, the second panel opening 142 can be smaller than the second compartment opening 132. In some embodiments, the third panel opening 144 can be smaller than the third compartment opening 134.

In some embodiments, the first compartment 121, the second compartment 122, the third compartment 123, and any other compartment(s) can each be constructed and arranged to accommodate a pet such as, for example, the house cat 15 in FIG. 1. In some embodiments, the first panel opening 140, the second panel opening 142, the third panel opening 144, and any other panel opening(s) can each be constructed and arranged to accommodate the house cat 15 in FIG. 1. The house cat 15 in FIG. 1 can enter any of the compartments 121, 122, 123 by entering a corresponding panel opening 140, 142, 144.

In some embodiments, the first compartment 121 can be constructed and arranged to accommodate one or more bowls 60. The one or more bowls 60 can be positioned inside the first compartment 121. In some embodiments, the second compartment 122 can be constructed and arranged to accommodate a pet bed such as a cat bed 80. The cat bed 80 can be positioned inside the second compartment 122. In some embodiments, the third compartment 134 can be constructed and arranged to accommodate a pet litter box 70. The pet litter box 70 can be positioned inside the third compartment 123.

An air purifier 99 can be in fluid communication with any compartment such as, for example, the third compartment 123. The air purifier 99 can be constructed and arranged to filter any air inside the third compartment 123.

In some embodiments, the pet housing apparatus 110 can include a first door 150 that is constructed and arranged to cover and close a first front opening 131 at a front side 114 of the furniture item 111. In some embodiments, the pet housing apparatus 110 can include a second door 152 that is constructed and arranged to cover and close a second front opening 133 at the front side 114 of the furniture item 111. In some embodiments, the pet housing apparatus 110 can include a third door 154 that is constructed and arranged to cover and close a third front opening 135 at the front side 114 of the furniture item 111.

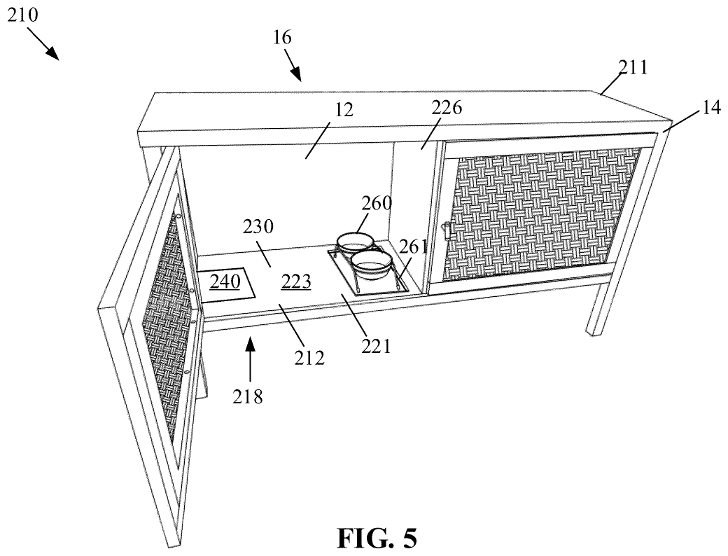

Referring to FIG. 5, in some embodiments, a pet housing apparatus 210 can include a first panel 12 that may not define a first panel opening (e.g., 40 in FIG. 1). In some embodiments, the pet housing apparatus 210 can include a second panel 212. In some embodiments, the second panel 212 can be adjacent to the first panel 12. In some embodiments, the second panel 212 can be positioned between a front side 14 and the back side 16 of a furniture item 211. In some embodiments, the second panel 212 can be constructed and arranged to at least partially cover a second compartment opening 230 at a bottom side 218 of the furniture item 211. In some embodiments, the second panel 212 can be constructed and arranged to at least partially define a second panel opening 240. In some embodiments, the second panel opening 240 can be smaller than the second compartment opening 230.

In some embodiments, the pet housing apparatus 210 can include the furniture item 211. In some embodiments, the second compartment opening 230 at the bottom side 218 of the furniture item 211 can be the second compartment opening 230 of a first compartment 221 of the furniture item 211. In some embodiments, a first enclosure 226 of the furniture item 211 can define the first compartment 221. In some embodiments, a bottom surface 223 of the first enclosure 226 can at least partially define the second panel opening 240. In some embodiments, a recess 261 in the bottom surface 223 of the first enclosure 226 can be constructed and arranged to receive one or more bowls 260 (e.g., pet bowls). In some embodiments, the first compartment 221 can be constructed and arranged to accommodate the one or more bowls 260.

In some embodiments, the first compartment 221 can be constructed and arranged to accommodate a pet such as, for example, a house cat (e.g., 15 in FIG. 1). In some embodiments, the second panel opening 240 can be constructed and arranged to accommodate a pet such as, for example, a house cat. The house cat can enter the first compartment 221 through the second panel opening 240. Accordingly, in some embodiments, the second panel opening 240 can be considered as a second pet opening 240.

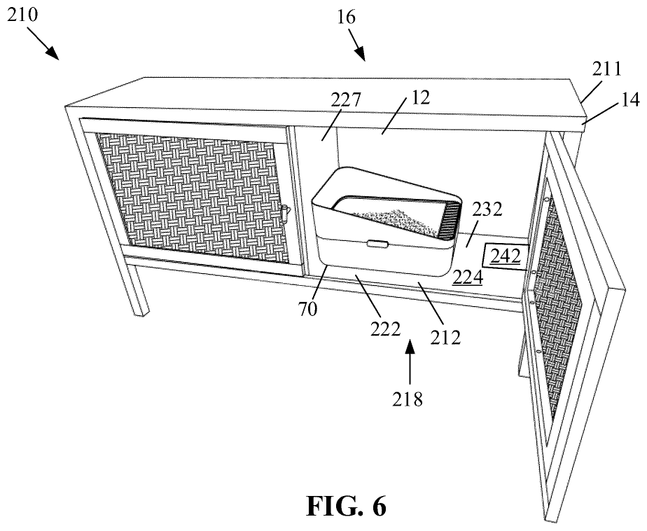

Referring to FIG. 6, in some embodiments, the second panel 212 can be constructed and arranged to at least partially cover a third compartment opening 232 at the bottom side 218 of the furniture item 211. In some embodiments, the second panel 212 can be constructed and arranged to at least partially define a third panel opening 242. In some embodiments, the third panel opening 242 can be smaller than the third compartment opening 232.

In some embodiments, the third compartment opening 232 at the bottom side 218 of the furniture item 211 can be the third compartment opening 232 of a second compartment 222 of the furniture item 211. In some embodiments, a second enclosure 227 of the furniture item 211 can define the second compartment 222. In some embodiments, the bottom surface 224 of the second enclosure 227 can at least partially define the third panel opening 242.

In some embodiments, the third panel opening 242 can be constructed and arranged to accommodate a pet such as, for example, a house cat (e.g., 15 in FIG. 1). The house cat can enter the second compartment 222 through the third panel opening 242. Accordingly, in some embodiments, the third panel opening 242 can be considered as a third pet opening 242.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a pet housing apparatus can include a panel, the panel being constructed to at least partially cover a first opening at a back side or bottom side of a furniture item; wherein the panel is further constructed to at least partially define a second opening; wherein the second opening is smaller than the first opening.

Variation 2 can include the pet housing apparatus of variation 1, wherein: the panel is constructed to have a first panel dimension that is substantially the same as a compartment opening dimension of the furniture item.

Variation 3 can include the pet housing apparatus of variation 1, wherein the panel includes a plurality of holes that are constructed and arranged to receive fasteners for fastening the panel to the back side or bottom side of the furniture item.

Variation 4 can include the pet housing apparatus of variation 1, wherein the second opening is constructed and arranged to accommodate a house cat.

Variation 5 can include the pet housing apparatus of variation 1, wherein the furniture item is a cabinet.

Variation 6 can include the pet housing apparatus of variation 1, wherein the panel comprises wood.

Variation 7 can include the pet housing apparatus of variation 1, wherein the second opening has a first dimension that is approximately 5 inches or larger, and wherein the second opening has a second dimension that is approximately 5 inches or larger.

According to variation 8, a pet housing apparatus can include a panel, the panel being constructed to at least partially cover a first opening at a back side or bottom side of a furniture item, the panel being further constructed to at least partially cover a second opening at the back side or bottom side of the furniture item; wherein the panel is further constructed to at least partially define a third opening; wherein the panel is further constructed to at least partially define a fourth opening; wherein the third opening is smaller than the first opening and the second opening; wherein the fourth opening is smaller than the first opening and the second opening.

Variation 9 can include the pet housing apparatus of variation 8, wherein: the panel is constructed to have a first panel dimension that is substantially the same as a compartment opening dimension of the furniture item.

Variation 10 can include the pet housing apparatus of variation 8, wherein the panel includes a plurality of holes that are constructed and arranged to receive fasteners for fastening the panel to the back side or bottom side of the furniture item.

Variation 11 can include the pet housing apparatus of variation 8, wherein the third opening is constructed and arranged to accommodate a house cat.

Variation 12 can include the pet housing apparatus of variation 8, wherein the furniture item is a cabinet.

Variation 13 can include the pet housing apparatus of variation 8, wherein the panel comprises wood.

Variation 14 can include the pet housing apparatus of variation 8, wherein the third opening has a first dimension that is approximately 5 inches or larger, and wherein the third opening has a second dimension that is approximately 5 inches or larger.

According to variation 15, a pet housing apparatus can include a panel, the panel being constructed to at least partially cover a first opening at a back side or bottom side of a furniture item, the panel being further constructed to at least partially cover a second opening at the back side or bottom side of the furniture item, the panel being further constructed to at least partially cover a third opening at the back side or bottom side of the furniture item; wherein the panel is further constructed to at least partially define a fourth opening; wherein the fourth opening is smaller than the first opening, the second opening, and the third opening.

Variation 16 can include the pet housing apparatus of variation 15, wherein: the panel is constructed to have a first panel dimension that is substantially the same as a compartment opening dimension of the furniture item.

Variation 17 can include the pet housing apparatus of variation 15, wherein the panel includes a plurality of holes that are constructed and arranged to receive fasteners for fastening the panel to the back side or bottom side of the furniture item.

Variation 18 can include the pet housing apparatus of variation 15, wherein the fourth opening is constructed and arranged to accommodate a house cat.

Variation 19 can include the pet housing apparatus of variation 15, wherein the furniture item is a cabinet.

Variation 20 can include the pet housing apparatus of variation 15, wherein the fourth opening has a first dimension that is approximately 5 inches or larger, and wherein the fourth opening has a second dimension that is approximately 5 inches or larger.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A pet housing apparatus, comprising:
a panel, the panel being constructed to at least partially cover a first opening at a back side or bottom side of a furniture item;
wherein the panel is further constructed to at least partially define a second opening;
wherein the second opening is smaller than the first opening.

2. The pet housing apparatus of claim 1, wherein:
the panel is constructed to have a first panel dimension that is substantially the same as a compartment opening dimension of the furniture item.

3. The pet housing apparatus of claim 1, wherein the panel includes a plurality of holes that are constructed and arranged to receive fasteners for fastening the panel to the back side or bottom side of the furniture item.

4. The pet housing apparatus of claim 1, wherein the second opening is constructed and arranged to accommodate a house cat.

5. The pet housing apparatus of claim 1, wherein the furniture item is a cabinet.

6. The pet housing apparatus of claim 1, wherein the panel comprises wood.

7. The pet housing apparatus of claim 1, wherein the second opening has a first dimension that is approximately 5 inches or larger, and wherein the second opening has a second dimension that is approximately 5 inches or larger.

8. A pet housing apparatus, comprising:
a panel, the panel being constructed to at least partially cover a first opening at a back side or bottom side of a furniture item, the panel being further constructed to at least partially cover a second opening at the back side or bottom side of the furniture item;
wherein the panel is further constructed to at least partially define a third opening;
wherein the panel is further constructed to at least partially define a fourth opening;
wherein the third opening is smaller than the first opening and the second opening;
wherein the fourth opening is smaller than the first opening and the second opening.

9. The pet housing apparatus of claim 8, wherein:
the panel is constructed to have a first panel dimension that is substantially the same as a compartment opening dimension of the furniture item.

10. The pet housing apparatus of claim 8, wherein the panel includes a plurality of holes that are constructed and arranged to receive fasteners for fastening the panel to the back side or bottom side of the furniture item.

11. The pet housing apparatus of claim 8, wherein the third opening is constructed and arranged to accommodate a house cat.

12. The pet housing apparatus of claim 8, wherein the furniture item is a cabinet.

13. The pet housing apparatus of claim 8, wherein the panel comprises wood.

14. The pet housing apparatus of claim 8, wherein the third opening has a first dimension that is approximately 5 inches or larger, and wherein the third opening has a second dimension that is approximately 5 inches or larger.

15. A pet housing apparatus, comprising:
a panel, the panel being constructed to at least partially cover a first opening at a back side or bottom side of a furniture item, the panel being further constructed to at least partially cover a second opening at the back side or bottom side of the furniture item, the panel being further constructed to at least partially cover a third opening at the back side or bottom side of the furniture item;
wherein the panel is further constructed to at least partially define a fourth opening;
wherein the fourth opening is smaller than the first opening, the second opening, and the third opening.

16. The pet housing apparatus of claim 15, wherein:
the panel is constructed to have a first panel dimension that is substantially the same as a compartment opening dimension of the furniture item.

17. The pet housing apparatus of claim 15, wherein the panel includes a plurality of holes that are constructed and arranged to receive fasteners for fastening the panel to the back side or bottom side of the furniture item.

18. The pet housing apparatus of claim 15, wherein the fourth opening is constructed and arranged to accommodate a house cat.

19. The pet housing apparatus of claim 15, wherein the furniture item is a cabinet.

20. The pet housing apparatus of claim 15, wherein the fourth opening has a first dimension that is approximately 5 inches or larger, and wherein the fourth opening has a second dimension that is approximately 5 inches or larger.
